(19) United States
(12) Patent Application Publication
(10) Pub. No.: US 2024/0241697 A1
(43) Pub. Date: Jul. 18, 2024

(54) EXTENSIBLE BUILT-IN OBJECT MANAGEMENT

(71) Applicant: Zoho Corporation Private Limited, Kanchipuram District (IN)

(72) Inventors: Sridhar Vembu, Tenkasi (IN); Akshhayaa S, Guduvanchery (IN)

(73) Assignee: Zoho Corporation Private Limited, Kanchipuram District, TN (IN)

(21) Appl. No.: 18/406,003

(22) Filed: Jan. 5, 2024

Related U.S. Application Data
(60) Provisional application No. 63/487,362, filed on Feb. 28, 2023.
(60) Provisional application No. 63/579,472, filed on Aug. 29, 2023.

(30) Foreign Application Priority Data
Jan. 13, 2023 (IN) 202341002897
Sep. 5, 2023 (IN) 202341059666
Nov. 20, 2023 (IN) 202341078773

(51) Int. Cl. G06F 8/20; G06F 8/30; G06F 9/448

(52) U.S. Cl. CPC G06F 8/24; G06F 8/315; G06F 9/449

(57) ABSTRACT

Extension of built-in object management functions such as create, update, and delete are illustrated. The developer can extend any of these functions for management of objects for a type within its type definition in source code. In one aspect, an object management function is extended to accept one or more additional arguments to capture one or more parameters, stored as metadata associated with the object, and accessible for use with further object management as well as other functions. In another aspect, one or more constraints are defined to implement control over management of an object of the extended type. At runtime, a constraint is evaluated, and, when the constraint evaluates to a predefined value, the object management function is prevented from completing.

### FIELD OF THE INVENTION

Embodiments of the present disclosure are related, in general, to computer programming languages and more particularly, but not exclusively, to extending built-in object management functionality.

### CROSS REFERENCE TO RELATED APPLICATION

This application is related to Indian Provisional Application 202341078773 filed 20 Nov. 2023, entitled “EXTENSIBLE BUILT-IN OBJECT MANAGEMENT”, which is incorporated herein by reference.

### BACKGROUND

A construct in a programming language refers to a particular syntactic structure or a piece of code that performs a specific task. Constructs are the basic building blocks of a program, and they can include various elements such as data types (integers, strings, etc., as well as user-defined), variables, operators, control structures (if statements, for loops, while loops, etc.), functions and procedures, classes and objects, modules and packages, and exception handling constructs. A construct may be comprised of multiple constructs, such as a block of code. Each programming language has its own set of constructs, and the way these constructs are used can vary from one language to another.

At the source code level, user-defined types pertain to structures, classes, interfaces, and other composite data types that programmers define to represent and manipulate complex data structures more effectively. These types go beyond the basic data types like int, float, and char that most languages offer inherently. User-defined types allow for the encapsulation of data and related functionality into cohesive units. At compile time, the compiler checks these types for syntactic and semantic correctness. This includes ensuring that the members of a class or structure are correctly defined, that methods are properly declared and implemented, and that any inheritance or interface implementation is correctly specified. The primary goal during this phase is to ensure that the code adheres to the language's syntax and semantics, and if it doesn't, to provide meaningful feedback to the developer.

Once the source code is compiled and becomes an executable, the user-defined types are transformed into machine code, ready for execution. At runtime, when these types are instantiated, memory is allocated for the resulting objects. For languages with manual memory management like C++, the developer allocates memory for objects using constructs like ‘new’ and releases memory with ‘delete’. In contrast, languages with garbage collection, such as Java or C#, handle memory deallocation automatically once objects are no longer reachable. The runtime environment is responsible for managing the object lifecycle, ensuring that constructors are called when an object is created, and destructors (if applicable) are called when an object is destroyed.

The management of these objects and the execution of associated methods form the core of runtime object management based on user-defined types.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1 is a compile and runtime environment 100 introducing various aspects of an example embodiment.

FIG. 2 illustrates how source code 110 written in accordance with one embodiment is compiled into an Intermediate Representation (IR) 205 and then optimized and further compiled into a program executable 130.

FIG. 3 is example source code 110 illustrating various aspects of extensible built-in object management.

FIG. 4 is a flowchart 400 illustrating a method for extending built-in object management at runtime.

FIG. 5 is a block diagram 500 illustrating a general embodiment of an extensible runtime object management engine 122.

FIG. 6A is a flowchart 600 illustrating how a compiler passes through several phases to convert source code written in a high-level language into machine code, including processing object management extensions.

FIG. 6B depicts object management extension manager 625 of FIG. 6A in accordance with one embodiment.

FIG. 7 illustrates an example embodiment of compile environment 700 using the types/messages for object management described above.

FIGS. 8A-8G illustrate runtime object creation, updating and deletion, as well as support objects from messages according to an embodiment such as described in FIG. 7.

FIG. 9 depicts a prior art general-purpose computing system.

### DETAILED DESCRIPTION

A programming language provides for user defined types, which, when compiled, produce instructions for the use of objects of the defined type. Types are defined for use in instantiating objects at runtime. Objects can be affected by object management instructions compiled from object management constructs. Examples detailed herein are create, update, and delete. Create, update, and delete functionality is built into the example compiler and accessible to developers using the example programming language. These functions can be extended by a developer to customize the functionality. Embodiments are described below illustrating various aspects.

Extension of create, update, and delete are illustrated. The developer, in one embodiment, can extend any of these functions for management of objects for a type within its type definition in source code (alternate embodiments accomplish the same). In one aspect, an object management function is extended to accept one or more additional arguments to capture one or more parameters, stored as metadata associated with the object, and accessible for use with further object management as well as other functions. In another aspect, one or more constraints are defined to implement control over management of an object of the extended type. At runtime, a constraint is evaluated, and, when the constraint evaluates to a predefined value, the object management function is prevented from completing.

An example embodiment to implement object management is described, using messages (or types) for create, delete, and update. When instructions compiled from these constructs are encountered in runtime, object management support objects are created for any message that has been generated. Instructions compiled from a trigger construct, <- in this example, activate the object management function associated with the message. This embodiment is useful for object management in general, and highlights one technique for implementing extension of create, update, and delete (other alternate embodiments are possible).

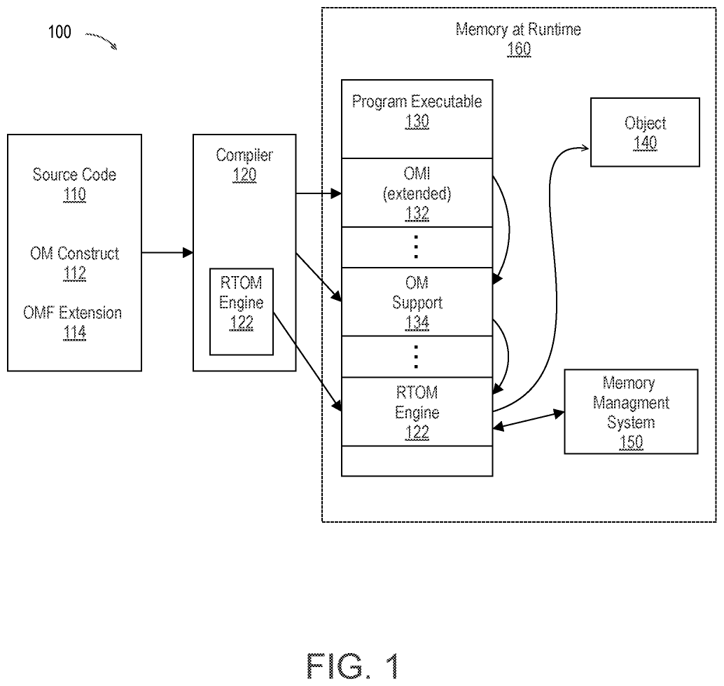

FIG. 1 is a compile and runtime environment 100 introducing various aspects of an example embodiment. Source code 110 is received by compiler 120 and compiled into program executable 130. Source code 110 includes an object management construct 112, which identifies a built-in object management function used to affect objects at runtime, such as create, update, or delete. An object management construct 112 is compiled into Object Management Instructions (OMI) 132.

Source code 110 includes an Object Management Function (OMF) extension 114. An OMF extension is a construct optionally used by a developer to extend the functionality of a built-in object management function for a particular type. When an OM construct 112 is extended by an OMF extension 114, compiler 120 compiles the object management instructions 132 into program executable 130, extended for the type as defined by the OMF extension 114. Compiler 120 also emits any object management support functionality necessary to implement the extended OMI 132 with the built-in functionality. In the example embodiment, instructions are emitted in intermediate representation format and compiled into object management (OM) support instructions 134.

Compiler 120 emits a Runtime Object Management (RTOM) engine 122 into program executable 130. RTOM engine 122 includes the built-in functionality for the object management functions and can interface with compiled object management instructions 132. Each function is configured to be extensible in response to an OMF extension 114, with support from OM support instructions 134 as necessary. RTOM engine 122 may include other built-in functions for supporting object management, such as creating and managing object management support objects (e.g., as derived from messages), providing support for escrowed history of object management actions, accessing that history, and accessing object management function metadata.

In the example embodiment, RTOM engine 122 is emitted as pre-compiled executable code. In an alternate embodiment, this engine, an intrinsic function to the compiler, is emitted into an intermediate representation (IR) for further compilation along with the object management constructs and extensions. The layout of memory 160 is illustrative only. Executable code can be loaded in any portion of memory, contiguously or otherwise, in similar order to the stored executable, or rearranged, or in any other configuration. The same is true for objects and other runtime data. It is common practice for instructions to be stored in a stack, and object data to be stored in a heap, but any memory management technique may be employed.

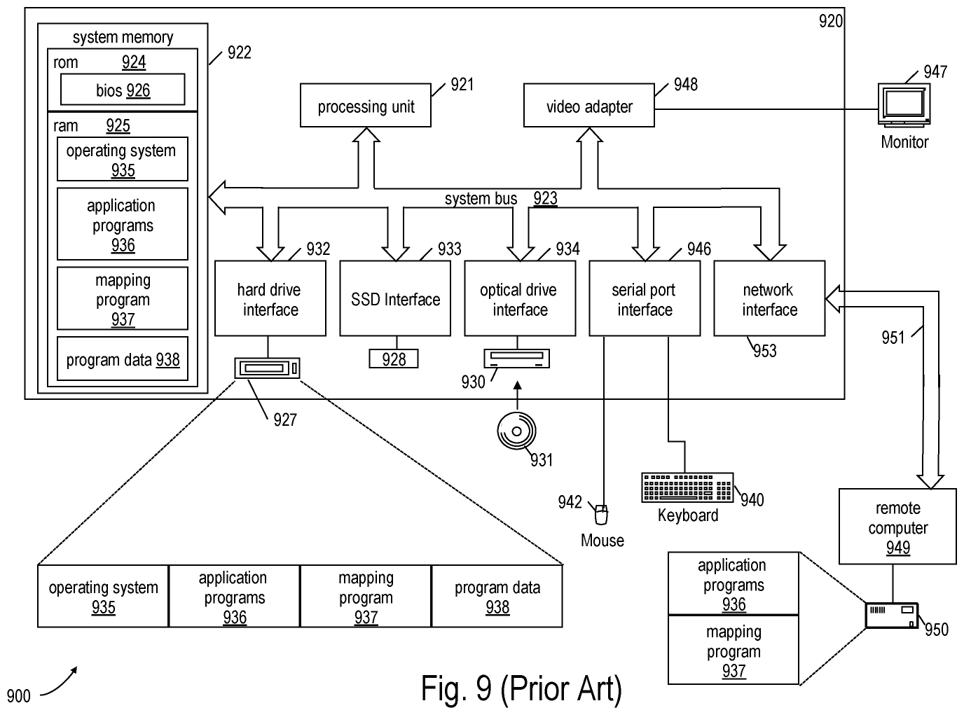

Compile and runtime environment 100 may be implemented on a computer such as prior art computer detailed below in FIG. 9. Shown together here for convenience only, it is not necessary to have the runtime environment and compile environment on the same device. Compiled executable programs can be distributed for executing in any number of implemented runtime environments. At runtime, a memory 160 is loaded with executable programs, in this example, program executable 130 and memory management system 150, which, among other desired functionality of program executable 130, facilitate object management. Note that memory management system 150 is shown discretely for illustrative purposes only. It, along with other instructions described herein, are collectively part of the executable code required for runtime support and may be combined in various embodiments. This example illustrates OMI 132 and OM support instructions 134 interfacing with RTOM engine 122 to affect object 140.

When an object management instruction 132 is encountered at runtime, RTOM engine 122 is invoked to perform the object management function. In one embodiment, RTOM engine 122 can support object management instructions 132 directly when the object management function has not been extended. In this illustration, OMI 132 has been extended, so a call to OM support instructions 134 is made to provide any type-specific extended functionality in the call to RTOM engine 122. Example extensions for various functions are detailed below.

RTOM engine 122 communicates with memory management system 150 to affect object 140. If OMI 132 is a create instruction, then memory allocation and other object constructor instructions may be carried out to implement instantiation of object 140 in memory 160. Memory management system 150 maintains object tables and other data structures for support of object management. If an update or delete function is identified by OMI 132 for an object, memory management system provides location and support for updating or deleting object 140.

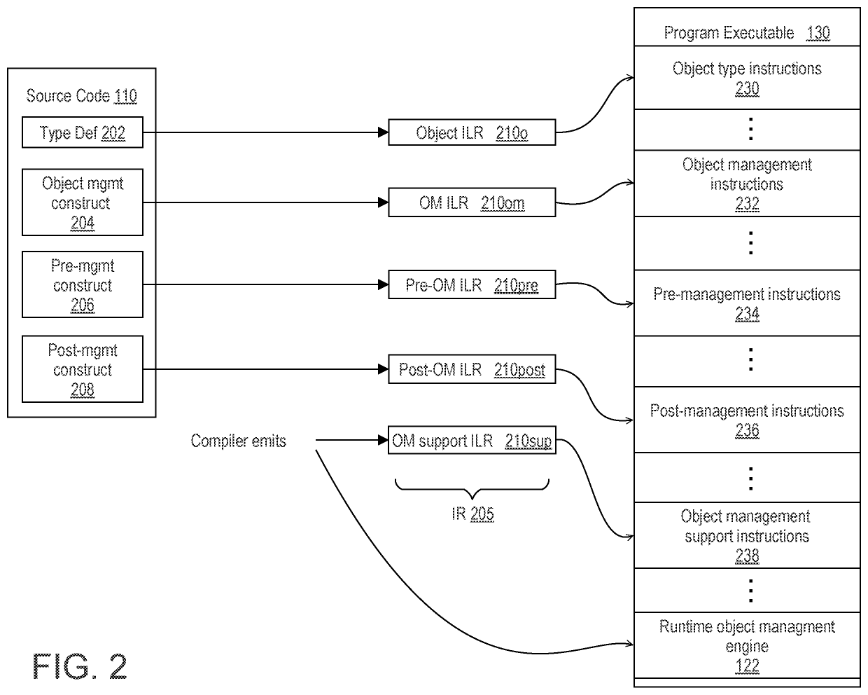

FIG. 2 illustrates how source code 110 written in accordance with one embodiment is compiled into an Intermediate Representation (IR) 205 and then optimized and further compiled into a program executable 130. Each data type definition 202, each object management construct 204, pre-management constructs 206 (if any), and post-management constructs 208 (if any) are compiled from source code 110 into Object Intermediate-Language Representation (ILR) 210o, OM ILR 210om, Pre-OM ILR 210pre, and post-OM ILR 210post, respectively.

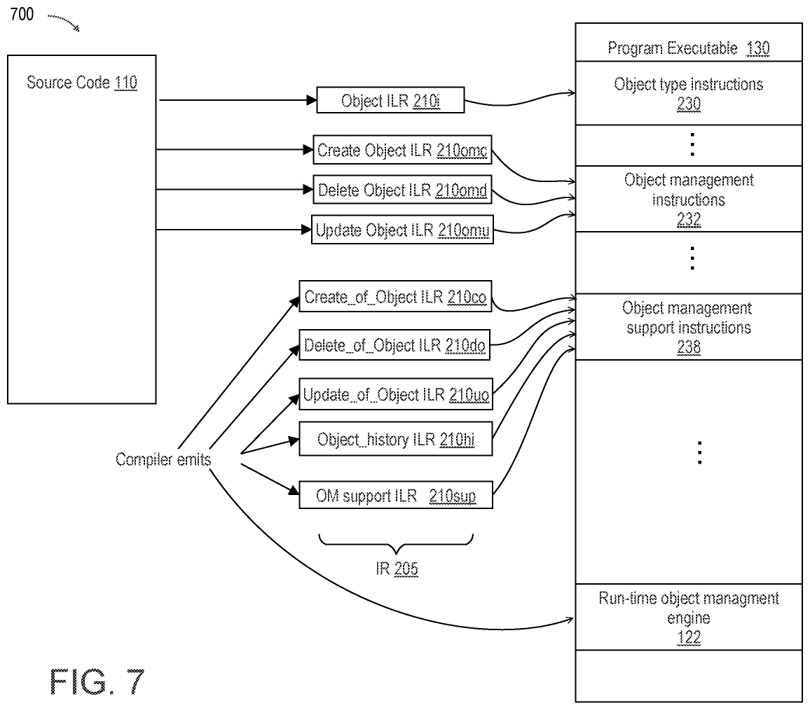

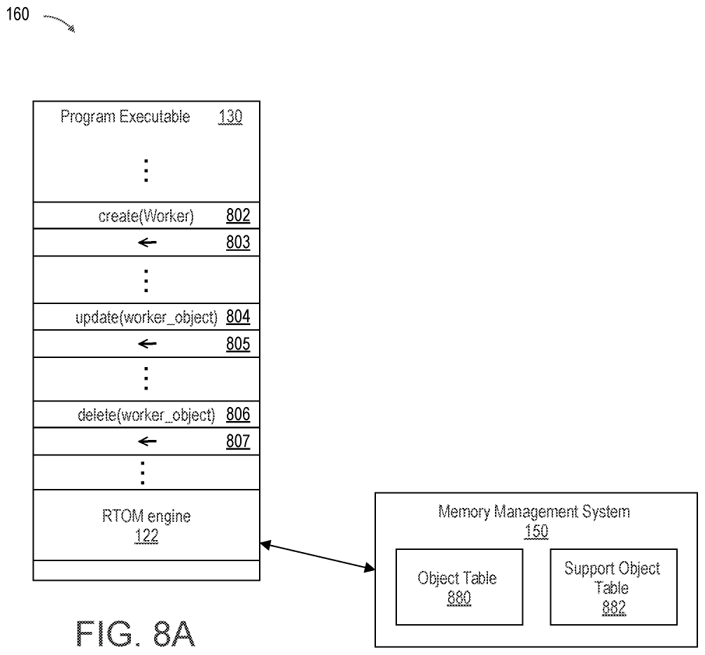

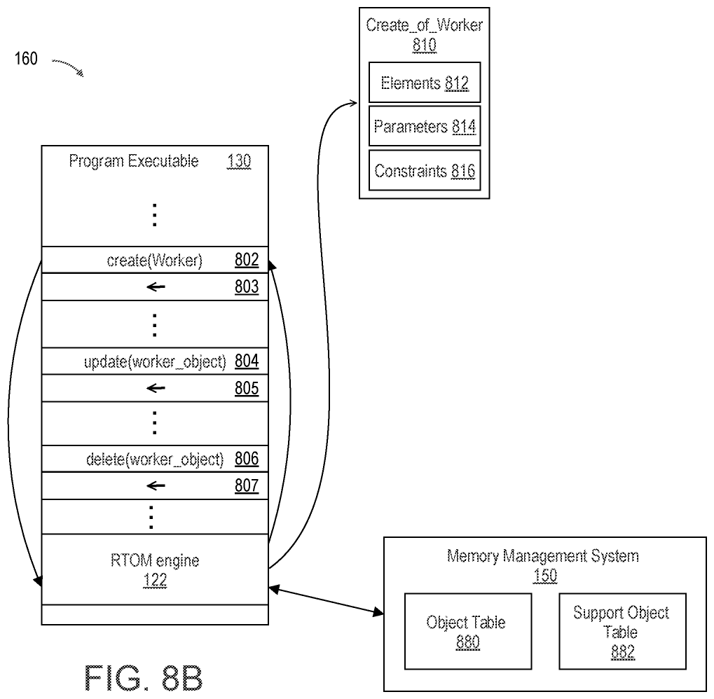

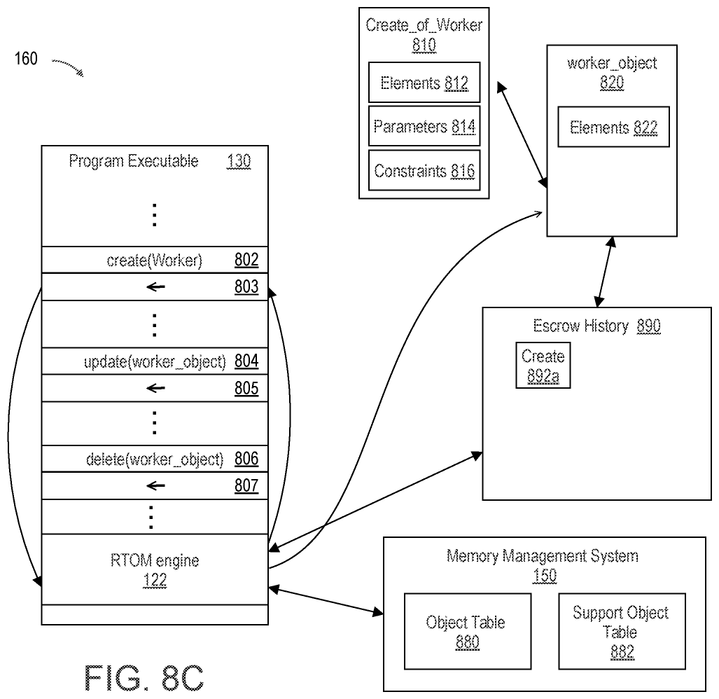

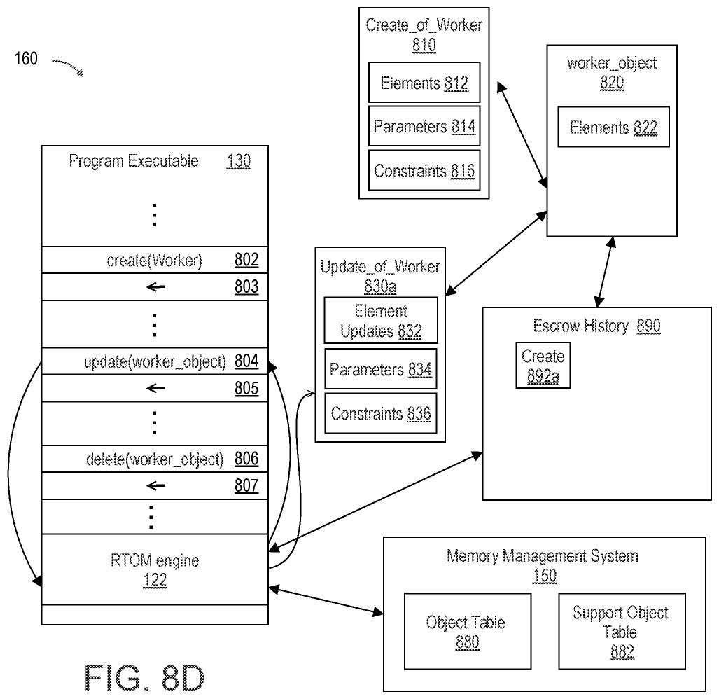

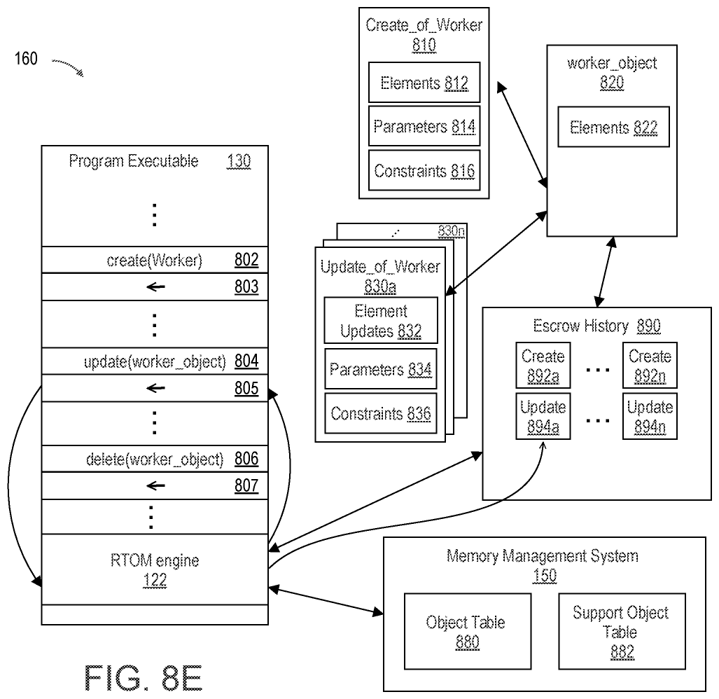

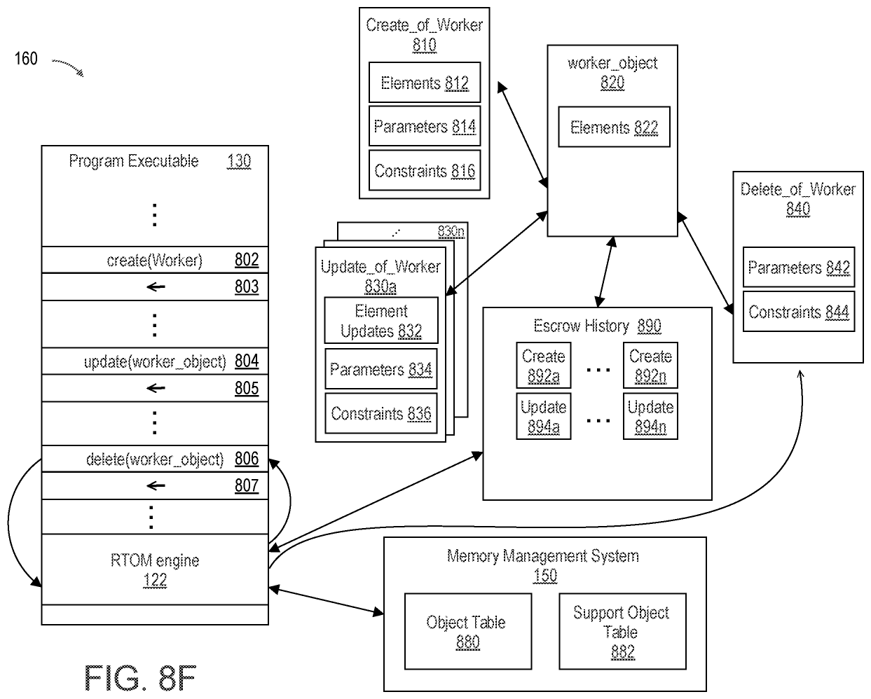

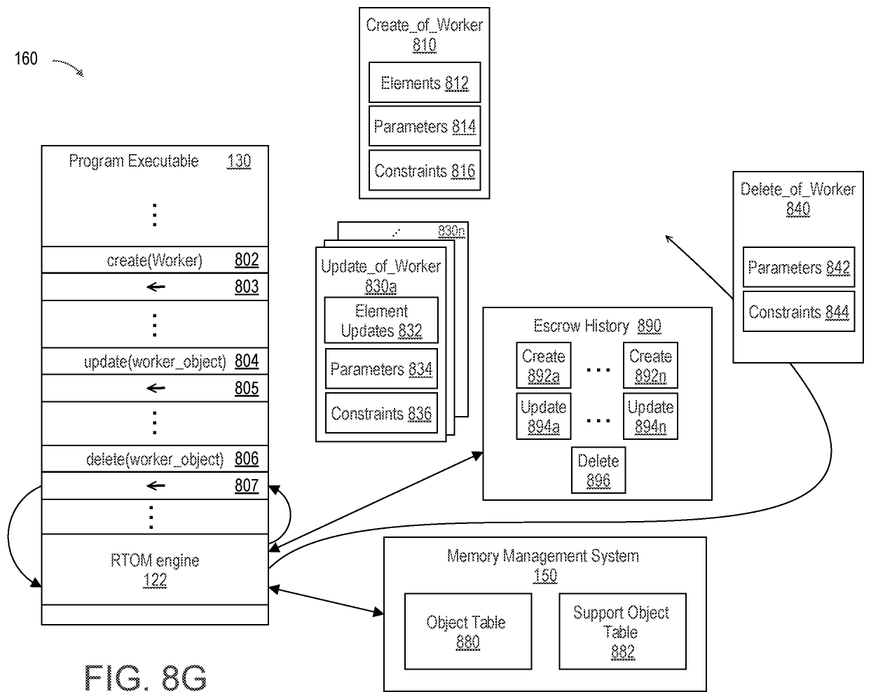

An object management construct 204 is compiled into OM ILR 210om. Example constructs include create, update, and delete. OM ILR 210om will be further compiled into object management instructions 232. The object management instructions are operable with runtime object management engine 122, which is emitted into the executable 130 with built-in functionality for object management, e.g., constructors for create, destructors for delete, and updating functionality, all of which can be extended, without overriding or amending the built-in functions. The compiler also emits code to support this extension, shown as OM support ILR 210sup, which is then further optimized and compiled into object management support instructions 238. An example embodiment is detailed below with respect to FIGS. 7 and 8.

A pre-management construct 206 may be optionally included, such as an event handler (detailed further below), or pre-management functionality may be built into RTOM engine 122. If included in source code, it will be compiled into Pre-OM ILR 210pre, and further optimized and compiled into pre-management instructions 234.

Post-management constructs 208 may also be included in source code 110, examples of which are detailed above, for compiling into post-OM ILR 210post, which is further compiled and optimized into post-management instructions 236.

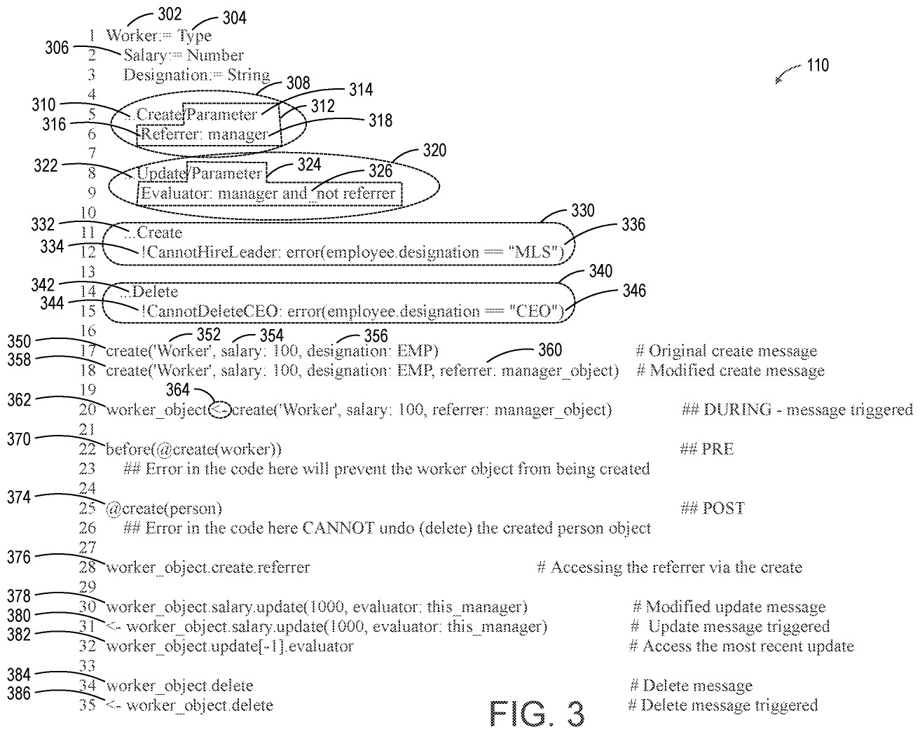

FIG. 3 is example source code 110 illustrating various aspects of extensible built-in object management, and illustrates various features depicted in FIG. 2. An example type definition 202 is shown in lines 1-15 as a type 304 named Worker 302. This type definition includes example object management extensions. Type worker is compiled into Object ILR 210o, and then further into executable object type instructions 230.

Example object management constructs are illustrated in FIG. 3. Lines 17-20 illustrate create constructs for type Worker. Lines 30-31 illustrate update constructs for type Worker. Lines 34-35 illustrate delete constructs for type Worker. These examples are detailed further below. Object management constructs are compiled into OM ILR 210om, and further compiled into executable object management instructions 232.

An example pre-management construct 206 is shown in lines 22-23 as before 370. It will be compiled into Pre-OM ILR 210pre and further compiled into executable pre-management instructions 234, which are invoked at runtime prior to initiating an object management function. An example post-management construct 208 is shown in lines 25-26 as @create 374. It will be compiled into Post-OM ILR 210post and further compiled into executable post-management instructions 236. Post-management instructions are invoked at runtime subsequent to completion of an object management function.

In addition to compiling the constructs from source code 110, the compiler emits runtime object management engine 122, described above. Based on the object management extensibility implementation, type definitions 202, and object management constructs 204, the compiler emits supporting functionality to implement object management instructions 232, as extended, utilizing RTOM engine 122. In one embodiment, messages create support objects utilized in affecting an object defined by a type definition 202. In an alternate embodiment, RTOM engine 122 is configurable to receive object management function calls with optional parameter extensions, and to perform constraint evaluation prior to completion of the object management functionality. Example techniques include adding an extensibility flag to identify additional parameters or a constraint. A pointer or other reference to a subroutine or function call to evaluate compiled constraints for managing an object may be provided via OM support instructions 238. Example embodiments are detailed further below.

Pre-management and post-management constructs can be combined with built-in object management extensions to support object management in general. Additionally, these combined techniques are useful to support systems of objects designed with inter-object functionality. For example, inheritance and type extensions can be deployed to support program maintenance and extensibility. Link types are defined wherein an Independent Data Type (IDT) is referenced in defining a Dependent-link Data Type (DDT). Examples of link types and dependencies, referred to therein as role sharing types and dependencies, are detailed in U.S. patent application Ser. No. 18/335,035 to Sridhar Vembu et al., filed 14 Jun. 2023, and entitled “Role Extensions For Programming Languages,” which is incorporated herein by reference.

A link-type object management engine may perform various checks at runtime prior to executing a link-type object management instruction. A variety of checks may be defined for different types and constructs, which are referred to generally as link type criteria. When defined link type criteria are satisfied for a link-type object management instruction for an object at runtime, the instruction is carried out. An example of pre-management instructions is an event handler that is invoked prior to initiating an object management function.

A compile-time link type manager may ensure that all link type object management constructs have associated event handlers at compile time, and that such an event handler meets certain criteria for the particular link type. An example compile-time link type manager enforcing source-code defined event handlers is detailed in copending U.S. patent application Ser. No. 18/405,699, entitled “Compile-time Link Type Object Management,” filed on 5 Jan. 2024, by Sridhar Vembu et al., which is incorporated herein by reference (hereinafter the '699 application).

In an alternate embodiment, an event handler in source code is not required, as a general-purpose runtime object management engine is provided for affecting link-type objects at runtime that may include one or more of the desired link-type criteria built in. The compiler can take into consideration any built-in link-type criteria and remove that from any event-handler requirements, as appropriate. Example embodiments are detailed in copending U.S. patent application Ser. No. 18/405,916, entitled “Runtime Support for Link Type Object Management,” filed on 5 Jan. 2024, by Sridhar Vembu et al., which is incorporated herein by reference (hereinafter the '916 application).

A source code event handler may be used when one is supplied, the event handler being called at runtime for the particular construct and type instead of the runtime object management engine. Compile time flags or design environment settings may indicate to a compiler to use one type of compile-time link type manager, or another, or any combination thereof.

These techniques can be combined with other embodiments detailed herein. For example, built-in object management functions that are extensible to include constraints which, when evaluated, either allow to continue or abort the object management function at runtime can be considered by a compiler evaluating whether an event handler has sufficient link-type criteria.

Example link-type criteria includes determining the existence of an IDT object, determining whether a dependency such as a DDT object exists, and evaluation of constraints specific to an object management function (e.g., create, update, or delete) or specific to a link object type (e.g., IDT or DDT). Link-type criteria can be evaluated in different phases. For example, an event handler, as just described, may be used to evaluate criteria prior to an object management function execution, like determining whether an IDT object exists prior to creating an object dependent on that object. Other link-type criteria may be evaluated during an object management function, using object management extensions as detailed herein.

The example source code 110 of FIG. 3 illustrates a type definition for objects of type worker, and various object management function examples highlighting extensibility. In the source code, “: =” denotes a type or element declaration and “:” denotes element or object usage. The use of pascal case (PascalCase) for object and element identifiers indicates a declaration and the use of snake case (snake_case) represents object and element usage. The delimiter “#” identifies comments.

In the example programming language create, update, and delete are referred to as messages to the compiler to perform object creation, updating and deletion respectively. Carrying out an object management function at runtime occurs in two or more steps. In the first step, the message is generated which identifies the function to perform and the arguments needed for that function and type. The message can be constructed in more than one step, updating or changing values in the message each time. When the function is to be invoked, a trigger construct, <- in the example embodiment, indicates that the message is ready to be deployed to affect the object at runtime. The following code snippet illustrates the general functionality:
1 ## Example messages. Use <- to trigger the message to affect the object
2 create(‘TypeName’, element: initial_value, . . . )
3 object.element.update(new_value_for_element)
4 object.delete
5 object <- create('TypeName', element: initial_value, . . . )
6 <- object.element.update(new_value_for_element)
7 <- object.delete

Here lines 2-4 illustrate code syntax for messages to create, update, and delete an object, respectively. Line 2 is a create message which identifies the type name, ‘TypeName’, which is an immutable scalar corresponding to a type, of the object to be created. It also accepts a listing of data elements and initial values of those elements. Line 3 illustrates an update message, including the object identifier for updating, object, and any elements for updating, element in this example, and a new value for the element being updated. Line 4 illustrates a delete message. It can simply identify the object for deletion.

In all these examples, at runtime, a message is generated in response to instructions compiled from these message constructs, but no object management will occur until a trigger instruction activating them is encountered. Lines 5-7 illustrate the same messages with the trigger included. In the example embodiment, messages generate support objects. The support object for a message is used to affect the object at runtime when a trigger instruction is encountered. The

RTOM engine 122 is used to generate the support objects, and to use those objects to affect the target object, in response to an object management instruction 232, as guided and assisted by the object management support instructions 238.

These examples illustrate the create, update, and delete messages having default compiler-defined behavior. This built-in behavior can be extended directly by a developer in source code, as illustrated in FIG. 3. The type construct for defining an object is identified by the keyword type 304 associated with the type name Worker 302. The type construct has at least one data element 306. In this example there are two data elements: Salary (a number) and Designation (a string). There are four illustrative extension constructs, 308, 320, 330, and 340, which are defined by the developer to extend the functionality of the associated object management function. Two extension constructs illustrate a parameter extension, one for the create function (308) and one for the update function (320). Two extension constructs illustrate constraint extensions, one for create (330) and one for delete (340).

As described above, a create function for an object of a type that has not been extended includes the type name as well as the one or more data elements defined and often their initial values (in alternate embodiments the object can be created with default values or placeholders, and those data elements can be populated at a later time). This is illustrated in line 17, which shows non-extended create construct 350. If the Worker type definition is not extended, i.e. it is fully defined by lines 1-3 and no extensions shown in lines 4-15 have been added, then the create message for a Worker object would be as shown in line 17, with create construct 350 having as arguments type name ‘Worker’ 352 and data elements salary 354 (initialized to 100) and designation 356 (initialized to EMP).

Additional parameters can be added by extending a type with a Create/Parameter, Update/Parameter, or a Delete/Parameter. Type Worker is extended with a Create/Parameter as illustrated in lines 5-6. Extension construct 308 has an extension indicator 310, . . . Create, wherein the . . . indicates extension and Create indicates that the create object management function is to be extended when operating at runtime on type Worker. The extension construct 308 defines extension instructions 312 for extending the create object management function. Here the extension instructions 312 include the Parameter keyword 314 indicating an additional argument Referrer 316 of type manager 318 needs to be included in the create function call. Extended create construct 358 is shown in line 18. Here the create construct is identical to the original create message 350, except that parameter 360 has been added. At runtime, when a create function extended with a parameter executes successfully, the parameter is stored associated with the create of that object. In this example the value for the parameter argument comes from a variable manager_object. A type may be extended with any number of parameters for any of the object management functions.

Create constructs 350 and 358 are examples of object management messages. When instructions compiled from an object management message are encountered at runtime, the message is created (or modified), but the object referenced by the type definition is not affected (that is, it is not created, updated, or deleted). An embodiment illustrating example message implementation is detailed further below. A trigger instruction encountered at runtime will trigger the object management function to potentially affect the object, which may be instantiation (create), modification (update), or removal (delete). Line 20 illustrates the trigger <-364 which compiles into instructions that, at runtime, may create worker_object 362 using a message identical to create message 358. In an alternate embodiment, object management messages may not be deployed, and a direct object management construct such as illustrated in line 20 may be deployed, which compiles into instructions that at runtime trigger the initiation of the object management function.

There are three distinct phases of execution of an object management function in the example embodiment, which are illustrated in source code 110 as PRE (lines 22-23), POST (lines 25-26), and DURING (line 20). As introduced in FIG. 2, a developer may include pre-management constructs 204, or post-management constructs 208, or both.

An example pre-management construct is an event handler that gets invoked when an object management function is triggered at runtime. The event handler has instructions to be executed prior to initiating the triggered object management function. Only after successful completion of the defined instructions does the program leave the PRE phase and initiate the function (i.e. enter the DURING phase). The before construct 370 is an example. When create(worker) is invoked (as a result of encountering an instruction compiled from line 20, for example), instructions compiled as defined by before construct 370 will be executed prior to initiating the create(worker) object management function (specific instructions not shown in FIG. 3).

If an error occurs during execution of the event handler instructions, then the object management function may never be initiated. Or event handler instructions may evaluate a condition and take a certain action to prepare for initiation of the object management function. For example, using link-type objects described above as an illustration, certain link-type criteria may be evaluated in an event handler. In one example, a delete function is called on an object of an independent data type. The event handler instructions may evaluate whether any objects dependent on that IDT object exist. If they do, then the delete function is not carried out. In another example, if a create instruction for a DDT object is encountered, the event handler may determine whether the associated IDT object exists. If it does, then the criteria are satisfied and the create object management function is executed. If it does not, the event handler may create the required IDT object, and then initiate the create function for the DDT object. If instructions compiled from a pre-management construct 234 are executed and the result is an error or other event or events predefined to do so, the object management instructions 232 are not initiated or completed. As the comment in line 23 specifies for the create example, an error in the event handler will prevent the object from being created.

An example post-management construct 374 is illustrated in line 25. Here, instructions associated with the @create(person) will be executed after the successful initiation and completion of the create(person) instructions. Specific instructions are not detailed in FIG. 3. Example post-management instructions could include, for example, any number of tasks that make sense once a worker object corresponding to a new employee has been instantiated. Perhaps an email is generated and sent to the new worker, which may include various pieces of information generated from other post-worker creation tasks that are specified by the employer. As noted in line 26, since these instructions occur after the object management function completes (e.g. the create worker), an error or other predefined occurrence in these instructions does not undo the object management action. In this case, the object has already been created, and that action is not undone (i.e. deleted, although naturally a delete function could be called as an additional instruction as necessary). Thus, the worker object has been successfully instantiated in memory, and any post-create instructions 234 defined have been executed (whether or not successfully).

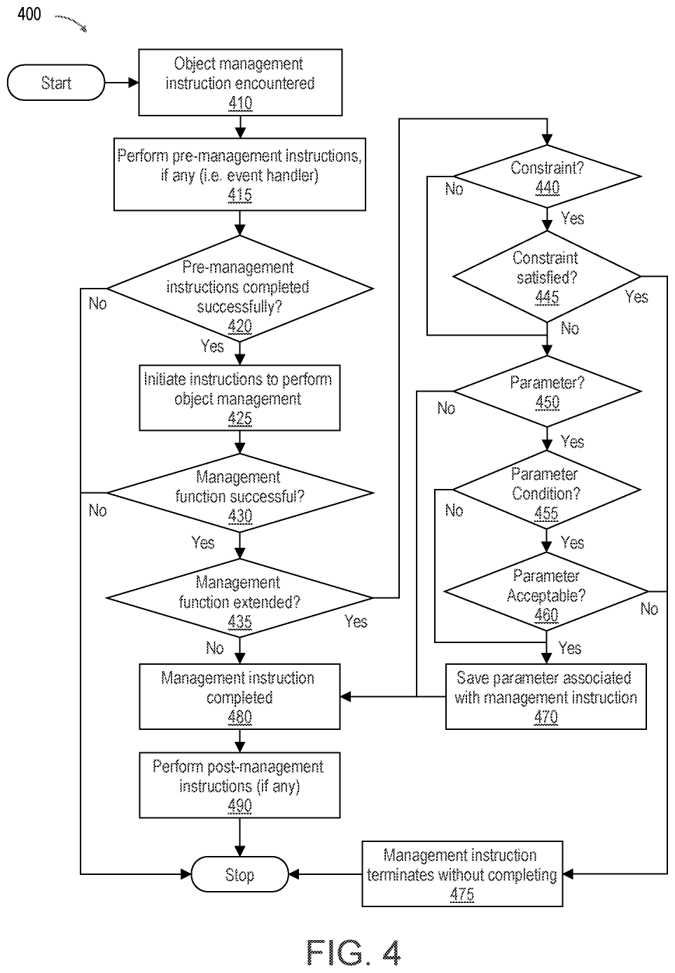

For application developers, in the example embodiment, the initiation of the DURING phase does not appear functionally different than the PRE phase. In the DURING phase, an object is marked for create, update, or delete, which is identical to the PRE phase in that the object has not been created/updated/deleted. Runtime behavior of the PRE, DURING, and POST phases of object management (as extended) is detailed further below with respect to FIG. 4. Extension construct 308 illustrated an extension adding a parameter to be saved alongside a create of an object at runtime. Extension constructs 320, 330, and 340 illustrate constructs which compile into instructions that may prevent the completion of object management instructions at runtime.

Line 8 includes an extension construct 320 extending the update function for type Worker. Extension construct 320 has an extension indicator 322, . . . Update, wherein the . . . indicates extension and Update indicates that the update object management function is to be extended when operating at runtime on type Worker. The extension construct 320 defines extension instructions 324 for extending the update object management function. Similar to the create extension 308, extension instructions 324 include a Parameter keyword indicating an additional argument Evaluator of type manager needs to be included in the update function call. However, in this extension, the evaluator type includes an expression 326, indicating that the Evaluator parameter should be a manager, but should not be the referrer, which was the parameter defined in the create extension 308.

The parameter for an update of worker will be added to the arguments already required for a non-extended update. An example worker update message 378 is shown in line 30. The object, worker_object, is to have its salary element updated, and the arguments to that message include the new value, 1000, and the additional argument for parameter evaluator, identified in this example with the variable this_manager. Line 31 illustrates the update function call 380, which has an identical message 378, but has the <- trigger construct to indicate that the update message is to be used to update the worker object. At runtime, the worker object, worker_object, will be updated with the new value, and the parameter for evaluator will be stored, so long as the expression 326 evaluates as defined in the extension instructions. If the expression does not evaluate to the defined value, an error will occur (in the DURING phase of the object management function), and the update will not complete.

Lines 11-12 illustrate a second extension construct 330 extending the create function for type Worker. Extension construct 330 has an extension indicator 332, . . . Create, as did extension construct 308. Here, however, the extension construct includes a constraint construct 334, labeled !CannotHireLeader, with an associated constraint expression 336, which defines an error when employee.designation==“MLS”). By convention, the “!” symbol is used to designate constraints.

In this example, a designation MLS indicates a worker is part of the leadership team. Company policy is designed so it only promotes internally, such that leadership positions are filled by existing employees. If a create instruction attempts to create a new worker with the leadership designation, that will violate company policy, so the constraint has been added to prevent that. At runtime, the constraint expression used to extend the create function for type worker will be evaluated, and if true, the create function is aborted. This is another example of an extension operating during the object management function, already initiated, which will prevent it from successfully completing. Contrast this with a constraint executed during a pre-management event handler, which would prevent the object management function from even initiating.

In the example create message 358, and the example create function call 362, the designation is EMP, in this example a non-leadership employee role. Therefore, at runtime, the create constraint will be evaluated, and not being satisfied, the constraint will not prevent the successful completion of the create, and the worker object will be created. In an embodiment employing messages and triggers for object management functions, it is a design choice whether a constraint expression is evaluated when the message is generated or modified, or when the message is triggered. Either design choice could be deployed depending on the context and requirements of the programming language. The same choice can be made for evaluating a parameter expression, such as parameter expression 326.

Note that various object management function messages share scope with each other, such that expression 326 of the update extension had the create parameter referrer available to it. Developers also have access to updates, and management function parameter values. For example, see the reference to worker_object.create.referrer 376 in line 28. This will return the parameter value for referrer that was saved at runtime during the worker_object create function. Or, in line 32, update reference 382 shows accessing the evaluator parameter value of the most recent update for worker_object. Updates in this embodiment are stored in an array accessible by an index value. In this embodiment, an index of −1 denotes the most recent (−2 indicates the second most recent, etc.). An index of 1 is the first, 2 is the second, and so forth. Any element of the update may be retrieved in addition to the parameter.

Lines 14-15 illustrate an extension construct 340 extending the delete function for type Worker. Extension construct 340 has an extension indicator 342, . . . Delete, and a constraint construct 344, labeled !CannotDeleteCEO. Associated constraint expression 346 defines an error when employee.designation==“CEO”). At runtime, when a delete instruction for a worker is encountered, the constraint expression is evaluated, and if it is satisfied, the delete function will be prevented. In this example, the logic is that a company should always have a chief executive officer. An existing CEO should be replaced by a new one, and have its designation modified. This example constraint prevents accidental deletion of a worker object with designation CEO. Line 34 illustrates an example delete message 384. Line 35 illustrates the triggered message 386 for a delete message deleting an object worker_object.

FIG. 4 is a flowchart 400 illustrating a method for extending built-in object management at runtime. An object management instruction is encountered (410), and pre-management instructions (if any), such as an event handler (whether compiled from source code or included in RTOM engine 122) are executed (415). It's possible that an event handler, as one example, finds that the object management instruction should not be completed (420), and if so, the process terminates (and the object is not affected by the object management function). If the pre-management instructions complete successfully, then the instructions to perform the object management are initiated (425).

There are instructions for each of create, update, and delete, built in to RTOM engine 122. As already described, those functions may be extended. In the example embodiment, the built-in functions are initiated first. This process could lead to an error for any of a variety of reasons. For example, a create function will typically require a memory allocation. A built-in create function may interact with the memory management system for a memory allocation, and find that process cannot complete, as memory is not available. If non-extended object management instructions are not able to execute successfully (430), an error is generated, and the process terminates without affecting the object. For example, a pending update or delete on an existing object does not occur. If an object creation has been initiated, it will not be completed, and any partial creation will be reversed (e.g. reallocating any reserved memory, removing any new entries to an object table, etc.). If no error is generated, and the management procedure is successful (430), then, if the management construct is not extended (435), the management instruction completes successfully (480).

If the management function is extended (435), additional steps based on the type of extension are performed. If the management function is extended with a constraint (440), then the constraint is evaluated (445). If the constraint evaluates to a predetermined value, then the constraint prevents the object management function from completing and the process terminates (475). At 475, an object nearly created (following 430) is aborted and not created. An object to be updated remains in its original state. An object to be deleted remains unchanged in memory.

If the extension does not include a constraint (440) or the constraint does not evaluate to a predetermined value for preventing the function to complete (445), then parameter extensions (if any) will be processed. If the extension comprises a parameter (450) then determine if the parameter has an associated condition to be evaluated (455). If so, determine if the parameter is acceptable based on the parameter condition (460). If the parameter is not acceptable, then the object management function is prevented from completing and the process terminates (475).

If the parameter does not have an associated condition to evaluate (455) or it does and is found acceptable (460), then the parameter is saved associated with the object management instruction associated and the object (470).

When an extended management function is not prevented by constraint (440 or 445), and either has no parameter (450) or the parameter is successfully saved (470), or when the management function is not extended (435), the management instruction completes 480. An object created during the operation exists in memory and is available for use. An object to be updated has its entity updated. An object for deletion is now removed from memory and is no longer accessible. Post-management instructions (if any) may be performed (490) before the process completes.

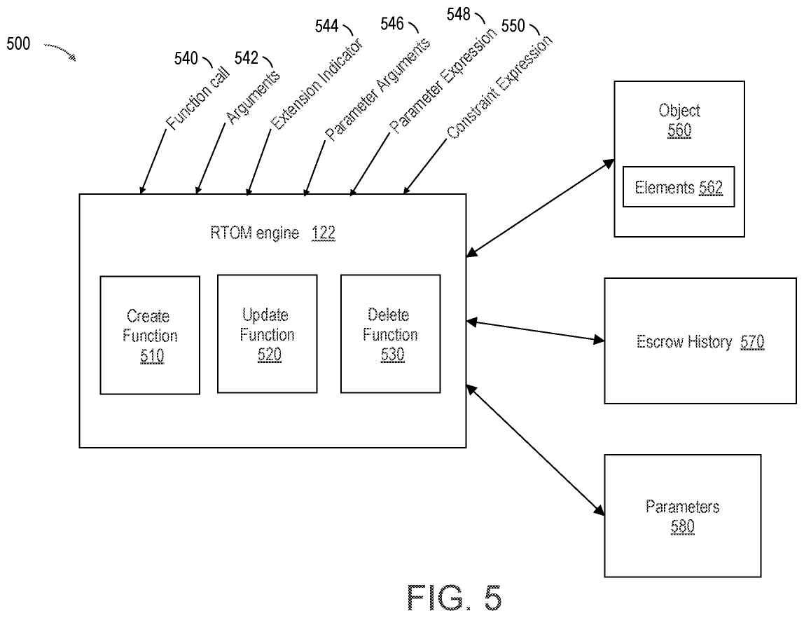

FIG. 5 is a block diagram 500 illustrating a general embodiment of an extensible runtime object management engine 122. RTOM engine 122 has built-in object management (OM) functions for create (510), update (520), and delete (530). The built-in functions are extensible, meaning optionally but not necessarily extended. A function call 540 accesses the RTOM engine 122 with arguments 542 (as necessary) and indicates which object management function is to be carried out. When a built-in OM function is accessed without extension, it may be used to affect object 560, containing one or more data elements 562. A create function 510 may be called (540) with arguments 542 to instantiate object 560 with initial values for elements 562. An update function 520 may be called (540) with one or more updated values 542 for elements 562. Or a delete function 530 may be called (540) potentially without arguments 542 to remove object 560 from memory. In this illustration, object 560, escrow history 570, and parameters 580 are instantiated and maintained in a memory such as memory 160 (details not shown).

The same calls and arguments can be made to access the object management functions as extended when indicated by extension indicator 544. As detailed above, an extension may include one or more parameters supplied by parameter arguments 546. An extension parameter may be conditionally saved based on evaluation of one or more parameter arguments 546. When an extension parameter is provided (and any parameter expression evaluated satisfactorily) it is stored in parameters 580.

When a constraint expression 550 is provided to extend an object management function, that expression is evaluated and if it evaluates to a predetermined value the object management function is terminated before completion, as described earlier.

The inputs shown are illustrative, and many other variants will be deployed by those of skill in the art. For example, a function call input 540 could include a variety of argument values to indicate not only the type of function to access (create 510, update 520, or delete 530) but also whether it is extended, and whether that extension is a constraint, parameter, or both. Parameter arguments 546 may be combined with arguments 542. An expression 548 or 550 may be a function call or a pointer to an expression. Objects 560, escrow history 570, and parameters 580 may be stored using any of a variety of techniques.

In one embodiment, illustrated in further detail in the following figures, object management functions are accessed with messages, embodied object as management support objects in the example, which include all necessary fields, variables, and expressions for management of an object, whether extended or not. In this example, an object management function is executed with a simple call to the RTOM engine 122 with a pointer to the desired object management support object. Parameters 580 are maintained within the support objects. Instructions to access escrow history 570 (maintained along with the support objects) are also provided.

In the example embodiment, messages are treated as types which generate support objects rather than being treated as functions or built-in methods. This is for two reasons. First, as described above, messages can be composed without triggering their action, so objects can be created and modified by messages composed over multiple steps. Second, by treating them as types, constraints and errors, properties, and other elements associated to types can be associated to messages. Once stored elements like “Evaluator” are introduced, there needs to be a way to access an update or create, for example, so that the stored element can be retrieved and read from. In that sense embodying messages as types is appropriate.

### Overview of Compiler

A compiler is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The following discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art, and an example of a prior art computer is detailed below in FIG. 9.

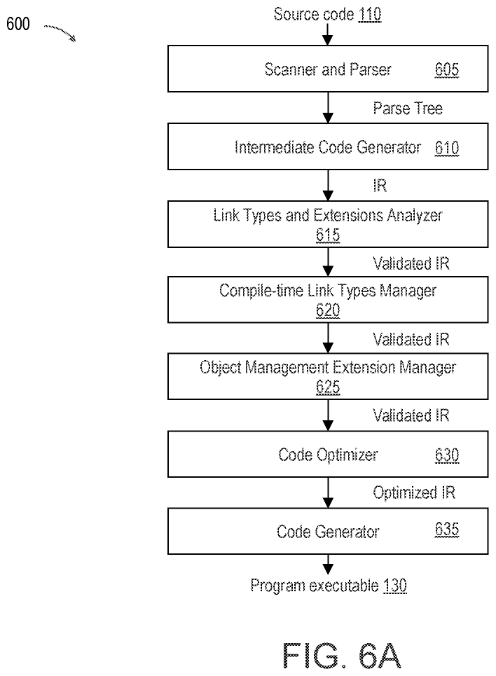

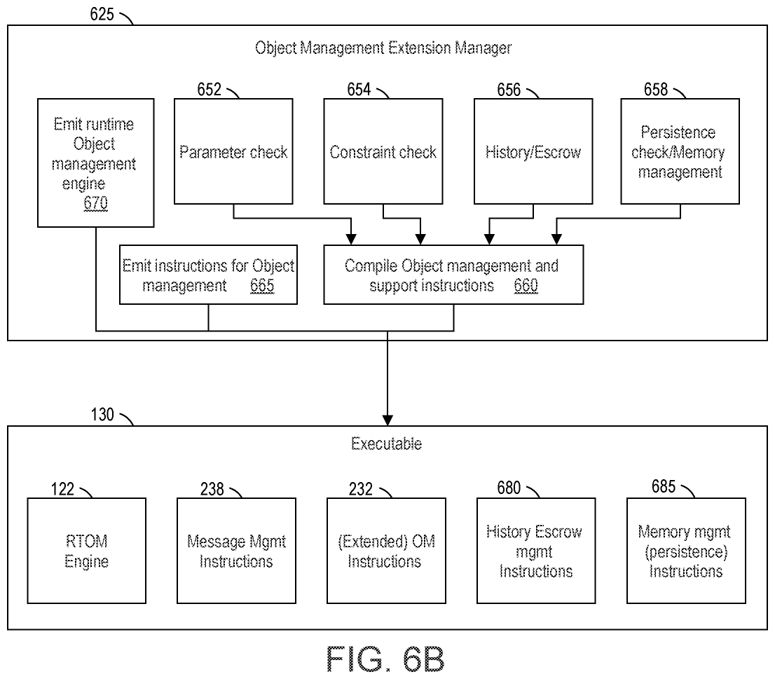

FIG. 6A is a flowchart 600 illustrating how a compiler passes through several phases to convert source code written in a high-level language into machine code, including processing object management extensions. Initially, the compiler scans and parses (605) the source code 110 to generate a parse tree. The generated parse tree is then fed to an intermediate code generator (610) from which an Intermediate Representation (IR) of the source code is obtained.

Link types and extension analyzer (615) operates on the IR using an extensibility checker, a dependency checker, and an element checker to semantically validate linked data types, IDTs and DDTs, as well as link type extensions and link type element extensions. Example embodiments are detailed in the '035 Vembu application incorporated by reference above. The result is a validated IR. As a result of this processing, the compiler has validated link type data types, and identified which are IDTs, which are DDTs, and which are both.

This validated IR is further processed by Compile-time Link Types Manager (620). Example embodiments of a compile-time link types manager 620 are detailed in the '699 and '916 Vembu applications incorporated by reference above. They define various mechanisms for evaluating link-type criteria for use in link-type object management. As stated previously, extensible built-in object management is useful with linked types for which Link types and extension analyzer (615) and Compile-time Link Types Manager (620) provide compiler support, but they are optional. Extensible built-in object management may be used with any object type.

Object management extension manager 625 further processes validated IR to analyze and compile built-in object management extensions in source code, and to emit and/or compile any object management support instructions and runtime object management instructions, as required.

Other embodiments may employ different or additional compiler phases processing the validated IR for other purposes. The validated IR serves as an input to the code optimization phase (630) from which the optimized IR is obtained. A code generator (635) then creates a program executable 130, specific to a target processor.

FIG. 6B depicts object management extension manager 625 of FIG. 6A in accordance with one embodiment. It includes parameter check 652, constraint check 654, history/escrow check 656 and persistence check/memory management function 658. Example embodiments are detailed below.

Object management extension manager 625 emits instructions (670) for the runtime object management engine 122, which has been detailed previously. The output of the functions 652-658 may include emitted ILR, source code ILR, or a combination. That output is compiled into object management and support instructions 660. Shown for illustrative purposes, executable code for one or more of these functions (or parts thereof) may be emitted as executable code 665. The combination of these compiled and emitted functions produces executable 130.

Parameter check 652 and constraint check 654 are used to identify those extensions within a type for any of the object management functions, and the object management functions as extended will be identified and compiled. Depending on the embodiment deployed, various support instructions may be emitted and compiled as well, detailed further below with respect to FIG. 7 (and illustrated in FIGS. 8A-8G).

History/escrow check 656 analyzes whether and how create history, updates, delete history, and parameters are stored and accessed in the source code and ensures that the appropriate support is provided. In one example, code for maintaining and accessing a history escrow (detailed further below) is provided as a built-in by the compiler (and emitted 665 or compiled from ILR 660, or a combination). Any type-specific instructions for history escrow may also be compiled. For illustration, in one example source code, while objects are created, updated, and deleted, the code does not include any constructs which would require access to the history of updates, creates, or any other data kept in history escrow. In that case, support for that access does not need to be incorporated into executable code. In alternate examples, all data or any subset of that historical data may be accessed, as identified by the source code, and the access code for interacting with the history escrow will be included. Thereby, history/escrow management instructions 680 record the object-specific operational events like create, update, and delete into secure and private storage that can be accessed only within the scope of the specific object.

The compiler can also determine whether support objects and/or escrow history need to persist, and to manage memory by removing them when that need ceases to exist. In one example, a message may be generated for creation of an object. However, the triggering of that creation is conditional. If the compiler determines based on source code when that possibility for creation no longer exists, then instructions to remove the support object generated by the create message are generated to remove that object at runtime, under those conditions where the possibility no longer exists. Also, based on the source code, it can be determined whether a create object needs to remain in memory after creation. Similarly, it may be that all support objects can be removed after an object's deletion. Whether any history or metadata is accessed as defined by the source code will dictate whether a particular piece of data or object needs to persist. Appropriate instructions may be introduced into executable 130 to enact the persistence and memory management check.

Examples of history use or persistence in source code are shown in FIG. 3. The use of referrer (a create parameter) in the expression 326 for update parameter evaluator lets the compiler know that the create parameter needs to persist as updates for the object are still possible. References to history such as worker_object.create.referrer 376 or worker_object.update[−1].evaluator 382 when used in source code also indicate the need for persistence.

Executable 130 combines the compiled and/or emitted code from the various components of the object management extension manager 625. In this example, it includes RTOM engine 122, message management instructions 238 (an embodiment of object management instructions detailed further below), Object management instructions (as extended) 232, history escrow management instructions 680, and memory management (or persistence) instructions 685. Note that RTOM 122 may be designed to include support for creation, updating, and deleting object management support objects in addition to the data objects for which they provide support (as illustrated in simplified examples shown in the FIGS. 8A-G). In that case, 665 emitted instructions may be incorporated into RTOM engine 122, or compiled into message management instructions 238, or any distribution or combination desired. They are shown separately for illustrative purposes only. (or compiled into 238, or any distribution or combination desired)

FIG. 7 illustrates an example embodiment of compile environment 700 using the types/messages for object management described above. As detailed in FIG. 2, source code 110 is compiled into program executable 130, comprising object type instructions 230, object management instructions 232, and object management support instructions 238. Object type instructions 230 are compiled from object ILR 210i, which may include extensions for one or more object management functions. And the object management instructions 232 are compiled from create, delete, and update instructions for the object, ILRs 210omc, 210omd, and 210omu, respectively.

Based on the type definition and constructs used in source code (including extension parameters or constraints, as well as other code that indicates whether or not support data structures are further accessed (and hence require persistence after an associated management function completes), the compiler emits the RTOM engine 122 with its built-ins. The compiler also emits support type definitions for the object management messages 210co, 210do, 210uo, and 210hi, along with any necessary OM support instructions 210sup. The combination included will depend on how the source code is defined. They are further compiled into object management support instructions 238.

Referring to the examples outlined with respect to FIG. 3, consider the create message 358 for type Worker. The compiler will emit ILR 210co instructions for that create message. When the create message instruction is encountered at runtime (compiled from ILR 210omc), a create worker support object is constructed. The elements of the support object will be determined by the type definition (Object ILR 210i). The support object (or message) will be created with elements corresponding to the data elements 306, Salary and Designation, and initial values for them, which will be used should the create message be triggered. In addition, the support object has an element for the create parameter referrer 316, as the create function for type worker has been extended. The create function for type worker is also extended with a constraint 330, !CannotHireLeader, will be stored as an element of the support object.

Similar support objects for update and delete will have instructions (210uo and 210do) emitted to define support objects when an update or delete message is encountered at runtime. Instructions to maintain an object's history (210hi) and any other instructions 210sup required to carry out support object maintenance and object management (in concert with RTOM engine 122) will be emitted for compiling into object management support instructions 238.

FIGS. 8A-8G illustrate runtime object creation, updating and deletion, as well as support objects from messages according to an embodiment such as described in FIG. 7. In FIG. 8A, memory 160 has program executable 130 (including create message 802, create trigger 803, update message 804, update trigger 805, delete message 806, and delete trigger 807), RTOM engine 122, and memory management system 150, including object table 880 as well as a support object table 882. In the examples of FIGS. 8A-8G, the instructions for creating, updating, and deleting data objects (such as type worker) as well as for creating, updating, and deleting support objects (Create_of_Worker, Update_of_Worker, and Delete_of_Worker) are incorporated into RTOM engine 122. There are initially no objects in memory 160.

The object management functions, when successful, as described above, occur in at least two steps (even if combined in a single construct in source code). First, a message is encountered, and an associated support object is created. The message may be updated as necessary any number of times. Second, the data object is affected by the message when a trigger instruction is encountered. In these examples the trigger is simplified with an <-indicator and the messages are simplified for illustration.

The support object defined by the message will be deleted when it is no longer necessary to support its associated data object. The detail of interplay between message instructions, trigger instructions, and other support instructions, including escrow history, memory management, and persistence instructions is not shown. Those of skill in the art will readily adapt these teachings to suitable embodiments based on desired design parameters.

FIG. 8B illustrates create message 802 being encountered, followed by a call to RTOM engine 122. A Create_of_Worker object 810 is constructed into memory. An example of supporting source code is line 18 of FIG. 3. It contains initial values for the data elements 812 defined for a Worker object, Salary, and Designation, in the example of FIG. 3. It also contains any extensions for creating worker_object, such as parameters 814 and constraints 816. It is maintained in support object table 882.

FIG. 8C illustrates the trigger 803 for “sending” the create message. Create_of_Worker support object 810 includes all the information needed for RTOM engine 122 to create the object, worker_object 820, in concert with memory management system 150. A call to RTOM engine 122 with a link to support object 810 initiates the create process.

An example create function, illustrated in FIG. 3, is extended with constraint 330. This constraint expression 816 is included in create support object 810, and it is evaluated prior to completion of worker_object 820, as detailed above with respect to FIG. 4. In this example, assume the constraint did not prevent the successful completion of the create function and so worker_object 820 is created. The initial values 812 for elements of data object worker_object stored in message 810 are instantiated as elements 822. Worker_object 820 exists, available in memory, and is maintained with object table 880. In addition, escrow history 890 has been updated with an entry 892a for the create function of worker_object. The initial values of elements 812 and other historical data such as time are stored in create entry 892a. Alternate embodiments will support storage of any data or metadata surrounding an object management function in escrow history 890.

FIG. 8D illustrates an update message 804 being encountered, followed by a call to RTOM engine 122. An Update_of_Worker object 830a is constructed into memory. It contains one or more element updates 832 and any extensions for updating worker_object 820, such as parameters 834 or constraints 836. It is maintained in support object table 882.

An example of an extended update message is shown in line 30 of FIG. 3. It contains an updated value for data element Salary defined for object worker_object. It also has extension parameter Evaluator with a value. The extension parameter is defined with a parameter expression, as described above. Here the Evaluator is constrained such that it should not be the original Referrer parameter of the worker create function. This will be evaluated if and when the update is triggered. Alternate embodiments may be designed to have parameter constraint checks occur when the message is updated.

FIG. 8E illustrates the trigger 805 for “sending” the update message. Update_of_Worker support object 830a includes all the information needed for RTOM engine 122 to update worker_object 820. A call to RTOM engine 122 with a link to support object 830 initiates the update process.

Here, using the example extended update of FIG. 3, the extension parameter expression needs to evaluate to a desired value for the parameter to be valid. The update function will fail if a parameter is invalid. There are no other constraints 836 in this example. The evaluator supplied in the update message was not the referrer from the create message, and so the update function defined by support object 830 is allowed to complete. Worker_object 820 has one or more elements 822 updated.

During the life cycle of an object, such as worker_object 820, multiple updates may be made. For each update message encountered at runtime, an Update_of_Worker object 830 is created, as illustrated by the sequence of objects 830a-830n. If and when each of the messages gets triggered (it is possible some do not), the respective objects 830 are used to update one or more elements 822 in worker_object 820.

In addition, for each update message triggered, escrow history 890 will be updated with an entry 894 for an update function of worker_object. A series of update history entries 894a to 894n are shown. The updated values 832, parameters 834, and other historical data such as time are stored in update entry 894a. (As parameters also exist in the Update_of_Worker object 830, it is not mandatory to store them in history escrow 890 but will be stored there in the example embodiment for convenience of access). The numbers for each update 894 do not necessarily correlate with the labels of update support objects 830, as an update message may not be triggered, so the object may exist but the update entry does not. Each object 830 need only contain the elements being updated, so will differ from each other according to the message that created them.

In an alternate embodiment, update data need not remain in an update support object 830. The desired data/history can be stored in escrow history 890 and the support object 830 deleted after triggering a successful update. In an alternate embodiment, no escrow history 890 needs to be deployed. As much historical data for create, update, and delete as is needed (which can be evaluated in the source code by the compiler) can be saved in the object management support objects, such as 820, 830, and 840 (introduced below). The collection of support objects is a complete and full version of each incident that affected the state of worker_object 820. An escrow history can be an object-focused diary of what has happened to the object. A link is shown between escrow history 890 and worker_object 820 to illustrate this feature. In various embodiments, any combination of these features and aspects can be deployed as desired based on design criteria.

Note that additional create entries (up to 892n) have been entered into escrow history 890 (details of these events are not shown in FIG. 8D and into 8E). An object is created once, so only a single create history may be needed in escrow 890 for an object. However, optional elements may be supported for a type in a programming language embodiment. In this case, the create of an object may occur initially with one or more optional elements not specified. One or more of those elements may be added (or “created”) at a later time, and those create events for one or a group of optional elements may have their own create history entry 892 stored in escrow history 890 (as illustrated by the additional create entries 892 in FIG. 8E.) A create construct may be used to add optional data elements to an already existing object. Or, in the example embodiment, an update construct is used to instantiate those optional elements (and may do so at the same time as updates for one or more other data elements of the object). When an optional data element is “created” by updating the object at a time subsequent to the object's creation, the runtime environment saves the initialized value in a create history entry in escrow history 890. Alternate embodiments are supported.

FIG. 8F illustrates a delete message 806 being encountered, followed by a call to RTOM engine 122. A Delete_of_Worker object 840 is constructed into memory. It contains any extensions for deleting worker_object, such as parameters 842 or constraints 844. It is maintained in support object table 882. Until the message is triggered, it does not affect worker_object 820, e.g., it is not yet deleted. As illustrated in example delete message 34 of FIG. 3, the only argument needed for a delete is the identity of the object to be deleted. The delete for type Worker is extended in this example, but with a constraint only, not a parameter. The constraint is stored in constraints 844. If one or more parameters were defined for the delete of worker, those parameter values would be added to the arguments for the message and stored in parameters 842.

FIG. 8G illustrates the trigger 807 for “sending” the delete message. Delete_of_Worker support object 840 includes all the information needed for RTOM engine 122 to delete worker_object 820. A call to RTOM engine 122 with a link to support object 840 initiates the delete process.

Here, using the example extended delete of FIG. 3, the constraint 844 is evaluated prior to completing the delete of object 820. The delete function will fail if the constraint evaluates to a predetermined value. The constraint prevents an employee with designation CEO from being deleted. Here, the designation is EMP, so the constraint does not prevent deletion. There are no other constraints 844 in this example. RTOM engine 122 deletes object 820. It no longer exists in memory, as shown. It is removed from object table 880.

In addition, escrow history 890 will be updated with an entry 896 for the delete function of worker_object. Any parameters 844 and other historical data such as time are stored in create entry 896. The remaining support objects may persist, or may be deleted using memory management system 150, as determined by the needs of other instructions provided by the developer in source code 110. It is also a design choice whether or when to remove entries from escrow history 890.

FIG. 9 (prior art) depicts a general-purpose computing system 900 that can serve as a client or a server depending on the program modules and components included. One or more computers of the type depicted in computing system 900 can be configured to perform operations described above. For example, computing system 900 is suitable to run a compiler such as detailed above in FIGS. 6A and 6B. Computing system 900 may run program executable 160, in a runtime environment 100, embodying memory 160 of FIG. 1. Those of skill in the art will appreciate that the invention may be practiced using other system configurations, including hand-held devices, multiprocessor systems, microprocessor-based or programmable consumer electronics, network PCs, minicomputers, mainframe computers, and the like.

Computing system 900 includes a conventional computer 920, including a processing unit 921, a system memory 922, and a system bus 923 that couples various system components including the system memory to the processing unit 921. The system bus 923 may be any of several types of bus structures, including a memory bus or memory controller, a peripheral bus, and a local bus using any of a variety of bus architectures. The system memory includes read only memory (ROM) 924 and random-access memory (RAM) 925. A basic input/output system 926 (BIOS), containing the basic routines that help to transfer information between elements within the computer 920, such as during start-up, is stored in ROM 924. The computer 920 further includes a hard disk drive 927 for reading from and writing to a hard disk, not shown, a solid-state drive 928 (e.g., NAND flash memory), and an optical disk drive 930 for reading from or writing to an optical disk 931 (e.g., a CD or DVD). The hard disk drive 927 and optical disk drive 930 are connected to the system bus 923 by a hard disk drive interface 932 and an optical drive interface 934, respectively. The drives and their associated computer-readable media provide nonvolatile storage of computer readable instructions, data structures, program modules and other data for computer 920. Other types of computer-readable media can be used.

Program modules are stored on non-transitory, computer-readable media such as disk drive 927, solid state disk 928, optical disk 931, ROM 924, and RAM 925. The program modules include an operating system 935, one or more application programs 936, other program modules 937, and program data 938. An application program 936 can use other elements that reside in system memory 922 to perform the processes detailed above.

A user may enter commands and information into the computer 920 through input devices such as a keyboard 940 and pointing device 942. Other input devices (not shown) may include a microphone, joystick, game pad, satellite dish, scanner, or the like. These and other input devices are often connected to the processing unit 921 through a serial port interface 946 that is coupled to the system bus, but may be connected by other interfaces, such as a parallel port, game port, universal serial bus (USB), or various wireless options. A monitor 947 or other type of display device is also connected to the system bus 923 via an interface, such as a video adapter 948. In addition to the monitor, computers can include or be connected to other peripheral devices (not shown), such as speakers and printers.

The computer 920 may operate in a networked environment using logical connections to one or more remote computers, such as a remote computer 949. The remote computer 949 may be another computer, a server, a router, a network PC, a peer device, or other common network node, and typically includes many or all the elements described above relative to the computer 920. The logical connections depicted in FIG. 9 include a network connection 951, which can support a local area network (LAN) and/or a wide area network (WAN). Such networking environments are commonplace in offices, enterprise-wide computer networks, intranets, cellular data systems, and the Internet in general. Furthermore, network 951 may connect to any number of distributed systems such as cloud-based storage or other web-based applications.

Computer 920 includes a network interface 953 to communicate with remote computer 949 via network connection 951. In a networked environment, program modules depicted relative to the computer 920, or portions thereof, may be stored in the remote memory storage device. It will be appreciated that the network connections shown are exemplary and other means of establishing a communication link between the computers may be used.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. Source code comprising:
a data type defining a data object, the data type having:
a type name;
at least one data element;
an extension indicator identifying an extensible object-management function; and
a construct defining an extension compilable to instructions for execution by the object-management function when operating on the data object defined by the data type.

2. The source code of claim 1, wherein:
the object-management function is configured to receive a set of arguments; and
the construct defines an additional argument for receiving by the object-management function prior to operating on the data object.

3. The source code of claim 2, wherein the construct defines an expression for evaluation by the object-management function;
the object-management function to store the additional argument responsive to the expression evaluated at runtime resulting in a predetermined value.

4. The source code of claim 2, wherein the construct defines the additional argument as a parameter and a parameter type.

5. The source code of claim 2, wherein the object-management function stores the additional argument as metadata associated with the data object when operating on the data object.

6. The source code of claim 1, wherein:
the construct defines a constraint expression;
the object-management function evaluates the constraint expression when operating on the data object; and
the object-management function terminates operating on the data object responsive to the constraint expression evaluation resulting in a predetermined value.

7. A method of executing a computer program, operable with a first data type defining a first object, the method comprising:
encountering a first instruction identifying an object-management function to affect the first object;
instantiating a second object having one or more elements operable with the object-management function to affect the first object;
encountering a second instruction initiating the object-management function for the first object; and
accessing the second object to affect the first object.

8. The method of claim 7, wherein:
the object-management function is a create function;
the first data type defines at least one data element;
the first instruction includes an initial value for the at least one data element;
the second object is instantiated including the initial value for the at least one data element; and
the second instruction identifies a first object name;
the method further comprising instantiating the first object with the first object name and the initial value accessed from the second object.

9. The method of claim 7, wherein:
the object-management function is an update function;
the first data type defines at least one data element;
the first instruction includes an update value for the at least one data element of the first object;
the second object is instantiated including the update value for the at least one data element of the first object; and
the method further comprising updating the first object with the update value accessed from the second object.

10. The method of claim 7, wherein:
the object-management function is a delete function;
the first instruction identifies the first object having an identity;
the second object is instantiated storing the identity; and
the method further comprising:
accessing the stored identity from the second object; and
deleting the first object with the identity accessed from the second object.

11. The method of claim 7, wherein:
the object-management function is configured to receive a set of arguments and extensible to receive an additional argument defined in the first data type;
the first instruction includes a value for the additional argument; and
the second object is instantiated with the value for the additional argument.

12. The method of claim 11, further comprising saving the value for the additional argument accessed from the second object as metadata associated with the first object.

13. The method of claim 7, wherein first data type defines a constraint expression for extending the object-management function and the second object is instantiated with the constraint expression, the method further comprising:
accessing the constraint expression from the second object;
evaluating the constraint expression; and
terminating the object-management function responsive to the constraint expression evaluating to a predetermined value.

14. A method of compiling source code having a data type for defining a first object, the method comprising:
encountering in the source code an object-management construct directed to the data type, the object-management construct identifying an object-management function for affecting the first object;
emitting a second type for defining an object-management support object associated with the object-management function and the data type;
compiling the object-management construct into type-specific instructions for accessing object-management instructions operable with the object-management support object; and
emitting the object-management instructions operable with the type-specific instructions and object-management support object to affect the first object at runtime.
